(19) United States
(12) Patent Application Publication
(10) Pub. No.: US 2008/0076085 A1
(43) Pub. Date: Mar. 27, 2008

(54) PORTAL FRAME DESIGN KILN

(75) Inventor: Philippe HATTON, Palaiseau (FR)

Correspondence Address: YOUNG & THOMPSON, 745 SOUTH 23RD STREET, 2ND FLOOR, ARLINGTON, VA, 22202, US

(73) Assignee: CERIC, Paris (FR)

(21) Appl. No.: 11/861,499

(22) Filed: Sep. 26, 2007

(30) Foreign Application Priority Data
Sep. 27, 2006 (FR) 06 08498

(51) Int. Cl. F27B 9/30

(52) U.S. Cl. 432/145; 432/150

(57) ABSTRACT

A portico furnace comprises a number of porticos (1), which are arranged parallel to one another and which define the spans of the furnace, and supports (2, 6) that are attached to said porticos (1), between which are positioned interjoists (3) that constitute the walls of the furnace.

At least some of the interjoists (3) consist of a chimney block (4) with an axis that is parallel to said supports (2, 6).

In a general manner, this invention relates to the furnaces that are used for firing products such as earthenware or ceramic products.

These furnaces usually come in the form of a tunnel of great length through which pass carriages bearing the products to be fired.

A circulation of fluid, air or any other suitable gas creates a gas stream that ensures the ventilation and the heating of the products for the purpose of their firing. The temperature, the hygrometric degree, and the displacement speed of the gas stream are continuously monitored so as to ensure a good-quality treatment of the products to be fired. In the usual manner, said gas stream enters the chamber by passing through wells or slots made in the wall of the latter, in the arches or in the lateral walls. Means, such as fans, are mounted in the ventilation circuit, usually outside of the chamber, to ensure the circulation of the gas stream.

The problem that arises in these chambers is tied to the fact that it is very difficult to obtain a uniform circulation of the gas stream around each of the products that are present in the chamber.

Numerous proposals have been made so as to improve the circulation of the gas stream by adding fans, deflectors, . . . but none have been totally satisfactory.

This invention aims to propose a device that is designed to cause a gas to circulate in a firing furnace, whereby said device is more particularly suited to being used in tunnel furnaces, which are usually referred to as portico furnaces. These furnaces derive their name from porticos in the shape of inverted U's, produced by a horizontal beam and two feet, arranged beside one another to form an external frame of the tunnel furnace that is designed to hold up the elements that constitute the chamber of the furnace.

The porticos that are placed outside of the furnace, above the upper wall of the latter, consist of metal sections.

Supports that are designed to attach the refractory wall of the furnace are held up by said porticos.

In the arches of the portico furnaces, suspension parts, held up by the horizontal beam of each portico, constitute a support that is similar to a small beam that is shaped overall like an inverted T arranged horizontally. Interjoists are positioned perpendicularly to said supports, resting on the stubs opposite the two supports that are close to one another.

The lateral walls of the furnace are made in a similar manner by supports that are attached to the feet of the porticos between which interjoists are positioned.

An insulating coating is put on the outside faces in the chamber of the furnace of the interjoists to reduce the losses of heat toward the outside from the useful space, or laboratory, of the furnace.

The suspension parts and the interjoists are made of, for example, refractory materials.

According to the invention, the portico furnace, which is of the type comprising a number of porticos arranged parallel to one another and defining the spans of the furnace and supports that are attached to said porticos between which interjoists that constitute the walls of the furnace are positioned, is characterized in that at least some of the interjoists consist of a chimney block with an axis that is parallel to said supports.

The furnace according to the invention is also noteworthy in that:
Said chimney blocks are positioned beside one another in a span and constitute a transverse and/or vertical pipe extending parallel to said supports,
The pipe extends over at least a portion of the length of the supports between which it is positioned,
A transverse pipe is connected to at least one vertical pipe,
Viewed overall, the chimney block has a rectangular cross-section,
Said chimney blocks are of different types, for example chimney-block-fan, distribution chimney block, end chimney block, simple chimney block, flap chimney block, . . .
A distribution chimney block comprises at least one seal that is arranged before an orifice,
A corner chimney block ensures the connection between a transverse pipe and a vertical pipe.

The invention also relates to a process for ventilation of a portico furnace according to the invention, characterized in that:
Transverse and/or vertical pipes are formed in at least some of the spans of the furnace by positioning interjoists in the form of a chimney block,
A gaseous fluid is circulated between the chamber of the furnace and said transverse and/or vertical pipes.

The process for ventilating a portico furnace according to the invention is also noteworthy in that:
A predetermined circulation of the gaseous fluid is obtained by selecting the chimney blocks that are designed to constitute each pipe from among a family that comprises, for example, chimney-block-fans, distribution chimney blocks, end chimney blocks, simple chimney blocks, flap chimney blocks, corner chimney blocks, . . . ,
At least some of the transverse and/or vertical pipes are connected to external fluid distribution means.

The invention will be better understood using the following description that is provided by way of nonlimiting example with reference to the accompanying drawings, in which:

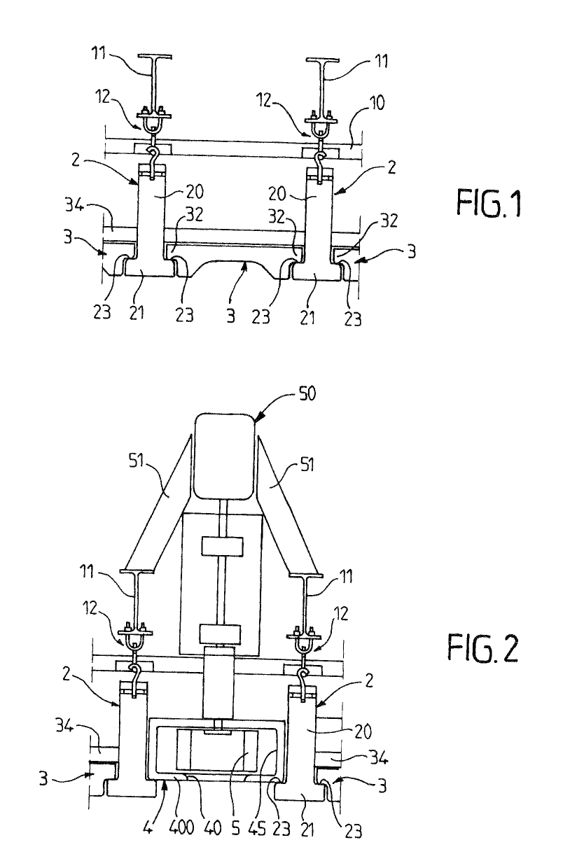

FIG. 1 is a partial cutaway view of the arches of a portico furnace, limited to one span overall,

FIG. 2 is a view that is similar to FIG. 1 for a portico furnace in which the invention is implemented according to a first embodiment, the section being made with a chimney-block-fan,

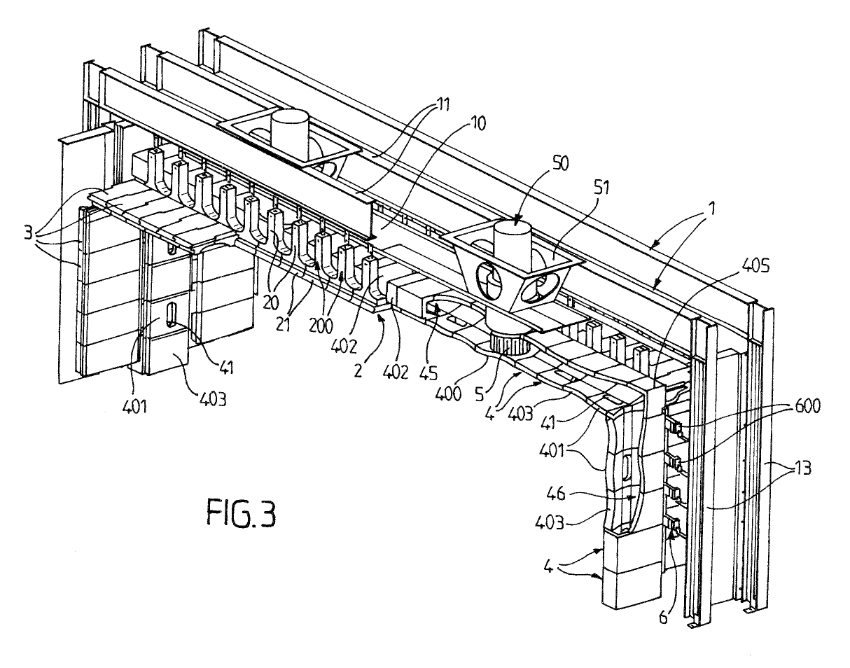

FIG. 3 is a partial perspective view of a portico furnace in which the invention is implemented according to a second embodiment.

As shown in FIG. 1, a portico furnace of the known type comprises a number of metal porticos 1 in the shape of inverted U's, consisting of a horizontal beam 11 and two feet 13. These porticos 1 are positioned parallel to one another and constitute an external frame of the furnace that is designed to support the elements that constitute the chamber of the furnace.

Two porticos 1 that are close to one another define among them a span 10 of the furnace.

Each horizontal beam 11 of the portico holds up, by the implementation of attachment means 12, a number of suspension parts 200 that are positioned beside one another.

Said suspension parts 200 constitute a horizontal support 2 that is similar to a small beam with a section in the shape of an inverted T. The cap 21 of such a support 2 is larger than the core 20 and, on both sides of this core 20, forms a support 23 that extends longitudinally over the entire length of said support 2.

Interjoists 3 that are parallelepipedic overall are positioned between two supports 2 that are close to one another by being oriented perpendicularly to said supports 2. Said interjoists that are shown in the drawing comprise projecting edges 32 that are mounted on supports 23 opposite the supports 2.

An insulating coating 34 covers the upper faces of the interjoists 3.

According to the invention, viewed overall, certain interjoists 3 consist of a chimney block 4 with a rectangular cross-section.

Said chimney blocks 4 replace the interjoists 3 and are positioned in the same way as the latter, beside one another in the width of the furnace, by being mounted on the supports 23 of the supports 2.

Said chimney blocks 4 that are positioned beside one another in a span constitute a transverse pipe 45 that extends parallel to said supports 2.

As could be understood, said transverse pipe 45 that is produced by the invention forms a passage in which it is possible to circulate a gaseous fluid that is intended to improve the ventilation of the parts during firing.

The transverse pipe 45 extends over at least a portion of the length of the supports 2 between which it is positioned; its length is defined by the number of chimney blocks 4 positioned beside one another.

In the embodiment shown in the drawing, the chimney blocks 4 extend completely between the cores 20 of the supports 2 and above the caps 21 of said supports 2 so as to propose a pipe 45 of the largest section possible.

According to a variant embodiment not shown in the drawing, the chimney blocks 4 comprise a lower portion that extends between the caps 21.

Like the other elements of the arches, suspension parts 200 and interjoists 3, the chimney blocks 4 are made of refractory material.

Different types of chimney blocks 4 are provided so as to fulfill various functions in the ventilation system and constitute a family of elements among which the designer of the furnace selects the predetermined gaseous fluid that is supposed to be obtained based on the circulation.

For example, the drawing shows a chimmey-block-fan 400 in which a fan 5 is positioned, and said fan draws in or blows back the gas stream through an opening 40 of the lower face thereof that is turned toward the laboratory of the furnace, i.e., toward the space in which the products to be fired circulate. Said fan is entrained by means 50 that are shown diagrammatically in the drawing and held up by the porticos 1 by the implementation of means 51. Two embodiments and forms of assembly of a fan are shown in FIGS. 2 and 3 by way of example.

Distribution chimney blocks 401 are visible in FIG. 3; they have at least one orifice 41 in their lower face that is turned toward the laboratory of the furnace. In an embodiment that is not shown in the drawing, seals that can be controlled remotely are arranged in front of the orifices 41 of said distribution chimney blocks 401 so as to make possible the adjustment of the size of the free passage.

End chimney blocks 402 are also shown in the drawing; these chimney blocks 402 have an end that is closed by a transverse wall 42 that defines the end of the pipe 45.

Other chimney blocks can be added to this family, for example a simple chimney block 403 that constitutes a portion of transverse pipe 45 but does not have a particular element or a flap chimney block in which a flap, optionally adjustable from the outside, makes it possible to reduce the section of the transverse pipe 45.

The transverse pipe 45 that is formed by the chimney blocks 4 is used to draw in the gaseous fluid that is present in the laboratory of the furnace and to feed it back toward said laboratory at different points along said pipe.

The fan 5 is selected so as to draw in the gaseous fluid that is present in the laboratory through the opening 40 of the chimney-block-fan 400 and to feed it back via the openings 41 of the distribution chimney blocks 401, or vice versa.

Two or more portions of transverse pipe 45 are created, if necessary, in the same span by arranging end chimney blocks 402 at suitable locations along supports 2; a transverse pipe 45 in two parts is shown by way of example in FIG. 3.

As can be seen in the drawing and more specifically in FIG. 3, the lateral walls of the furnace have a constitution that is similar to that of the arches and comprise attaching parts 600 that are attached to the feet 13 of the porticos 1 so as to constitute the vertical supports 6 between which are positioned interjoists 3 that are identical to those used in the arches.

According to the invention, in a span of the furnace, a vertical pipe 46 consists in at least one longitudinal wall of the furnace and is connected, if necessary, to the transverse pipe 45 that is arranged in the same span.

A vertical pipe 46 is produced in the same manner as a transverse pipe 45 according to the invention by replacing the interjoists 3 of a span by chimney blocks 4 that are selected from among the family of chimney blocks based on the gaseous fluid circulation that is to be ensured.

A corner chimney block 405 ensures the connection between a transverse pipe 45 and a vertical pipe 46.

As could be understood, the implementation of chimney blocks 4 according to the invention makes it possible to regulate as well as possible the circulation of the gas streams around the parts to be treated by adapting the position of the openings in the transverse and/or vertical pipes.

Among the family of elements of chimney blocks, several distribution chimney blocks 401 whose opening or openings 41 have different sections can be proposed.

By way of example, openings 41 are positioned along vertical pipes 46 at selected heights so as to ensure a priority circulation of the gas streams at the load carried by the cars or at suitable zones provided in the lower spaces of said cars.

According to an embodiment of the invention, not shown in the drawing, the transverse pipes 45 and vertical pipes 46 are connected to external fluid distribution means and can then be used to draw off gaseous fluid that circulates in the furnace and to replace it by injecting air or any other gaseous fluid.

For certain types of firing, it is also possible to use these pipes for providing an injection of gaseous or solid products, etc.

1. Portico furnace of the type that comprises a number of porticos (1) that are arranged in parallel to one another and that define the spans of the furnace, and supports (2, 6) that are attached to said porticos (1), between which are positioned interjoists (3) that constitute the walls of the furnace, characterized in that at least some of the interjoists (3) consist of a chimney block (4) with an axis that is parallel to said supports (2, 6).

2. Furnace according to claim 1, wherein said chimney blocks (4) are positioned beside one another in a span and constitute a transverse pipe (45) and/or a vertical pipe (46) extending parallel to said supports (2, 6).

3. Furnace according to claim 2, wherein said pipe (45) extends over at least a portion of the length of the supports (2, 6) between which it is positioned.

4. Furnace according to claim 2, wherein a transverse pipe (45) is connected to at least one vertical pipe (46).

5. Furnace according to claim 1, wherein viewed overall, the chimney block (4) has a rectangular cross-section.

6. Furnace according to claim 1, wherein said chimney blocks (4) are of different types, including: chimney-block-fan (400), distribution chimney block (401), end chimney block (402), simple chimney block (403), flap chimney block.

7. Furnace according to claim 2, wherein a corner chimney block (405) ensures the connection between the transverse pipe (45) and a vertical pipe (46).

8. Process for ventilation of a portico furnace according to claim 1, wherein:
Transverse pipes (45) and/or vertical pipes (46) are formed in at least some of the spans of the furnace by positioning interjoists in the form of a chimney block (4),
A gaseous fluid is circulated between the chamber of the furnace and said transverse pipes (45) and/or vertical pipes (46).

9. Process for ventilation of a portico furnace according to claim 8, wherein a predetermined circulation of the gaseous fluid is obtained by selecting the chimney blocks that are designed to constitute each pipe (45, 46) among a family that comprises, for example, chimney-block-fans (400), distribution chimney blocks (401), end chimney blocks (402), simple chimney blocks (403), flap chimney blocks, corner chimney blocks (405) . . . .

10. Process for ventilation of a portico furnace according to claim 8, wherein at least some of the transverse pipes and/or vertical pipes are connected to external fluid distribution means.

11. Process for ventilation of a portico furnace according to claim 9, wherein at least some of the transverse pipes and/or vertical pipes are connected to external fluid distribution means.

12. Furnace according to claim 3, wherein a transverse pipe (45) is connected to at least one vertical pipe (46).

13. Furnace according to claim 2, wherein viewed overall, the chimney block (4) has a rectangular cross-section.

14. Furnace according to claim 3, wherein viewed overall, the chimney block (4) has a rectangular cross-section.

15. Furnace according to claim 2, wherein said chimney blocks (4) are of different types, including: chimney-block-fan (400), distribution chimney block (401), end chimney block (402), simple chimney block (403), flap chimney block.

16. Furnace according to claim 3, wherein said chimney blocks (4) are of different types, including: chimney-block-fan (400), distribution chimney block (401), end chimney block (402), simple chimney block (403), flap chimney block.
